(19) United States
(12) Patent Application Publication
(10) Pub. No.: US 2017/0328096 A1
(43) Pub. Date: Nov. 16, 2017

(54) ADJUSTABLE BIN LATCH ASSEMBLY

(71) Applicant: ADAMS RITE AEROSPACE INC., Fullerton, CA (US)

(72) Inventors: Phillip G. Allen, Fullerton, CA (US); Brian LIEU, Fullerton, CA (US); Michael A. CHIEFFO, Fullerton, CA (US); Omar A. BANUELOS, Fullerton, CA (US); James J. SCHULZ, Fullerton, CA (US); Scott W. OVERTOOM, Fullerton, CA (US); Juan P. PEÑA, JR., Fullerton, CA (US)

(21) Appl. No.: 15/594,248

(22) Filed: May 12, 2017

Related U.S. Application Data
(60) Provisional application No. 62/335,661, filed on May 12, 2016.

(51) Int. Cl. E05C 9/04; E05C 9/18; E05C 9/00; B64D 11/00

(52) U.S. Cl. CPC E05C 9/04; E05C 9/1808; B64D 11/003; E05C 9/006; E05C 9/18

(57) ABSTRACT

An overhead compartment of an airplane includes a storage bin and a latch assembly. A latch mechanism of the latch assembly is selectively, controllably engageable and disengageable with a keeper to hold the overhead compartment in a stowed position, or an open position, respectively.

### PRIORITY CLAIM

This application claims priority under 35 U.S.C. §119(e) to U.S. Provisional Application Ser. No. 62/335,661, filed May 12, 2016, which is expressly incorporated by reference herein.

### BACKGROUND

The present disclosure relates generally to a latch assembly, and more specifically to an adjustable latch assembly for an aircraft overhead storage bin.

### SUMMARY

According to the present disclosure, an overhead compartment of an airplane includes a storage bin and a latch assembly. The latch assembly includes a latch mechanism that engages with a keeper to hold the overhead compartment in a stowed position.

In illustrative embodiments, the latch mechanism includes a lock pin, a keeper sensor, and a lock collar. The lock pin, keeper sensor, and lock collar are coupled to a spindle for relative movement therewith. The lock pin engages with the keeper to hold the keeper in the latch. The lock collar engages with the lock pin to hold the lock pin in engagement with the keeper. A push rod extends into the spindle to engage with the lock collar to move the lock collar relative to the spindle and allow disengagement of the lock pin from the keeper.

In illustrative embodiments, the spindle is coupled to a mount plate for attachment to the storage bin. The spindle is configured to pivot relative to the mount plate to angularly align with the keeper and allow engagement of the keeper with the lock pin. The mount plate is formed to include elongated apertures configured to receive fasteners for attachment of the mount plate to the storage bin and allow positional adjustment relative to the storage bin.

Other aims, objects, advantages and features of the disclosure will become more apparent upon reading of the following non-restrictive description of specific embodiments thereof, given by way of example only with reference to the accompanying drawings.

### BRIEF DESCRIPTION OF THE DRAWINGS

The present disclosure will be described hereafter with reference to the attached drawings which are given as a non-limiting example only, in which:

FIG. 1 is a perspective view of an overhead compartment showing that the overhead compartment includes a storage bin and a bin motion controller in accordance with the present disclosure and suggesting that the bin motion controller blocks or allows movement of the overhead compartment at the selection of a user;

FIG. 2 is a perspective view of a latch assembly of the bin motion controller of FIG. 1 showing that a keeper is received in a latch mechanism and suggesting that a lock pin of the latch mechanism engages with the keeper to block removal of the keeper;

FIG. 3 is a front elevation view of the latch mechanism of FIG. 1 showing a spindle of the latch mechanism coupled to a mount plate and suggesting that the spindle is pivotable relative to the mount plate to allow for variable entry angles of the keeper;

FIG. 4 is an exploded perspective view of the latch assembly of FIG. 1;

FIG. 5 is a view similar to FIG. 4;

FIG. 6 is a front perspective view of the latch assembly of FIG. 1 showing the keeper spaced apart from the latch mechanism;

FIG. 7 is a view similar to FIG. 6 showing the keeper received in the latch mechanism;

FIG. 8 is a rear perspective view of the latch of FIG. 6;

FIG. 9 is a sectional view taken along line 9-9 in FIG. 6 showing the lock pin engaged with a keeper sensor when the keeper is spaced apart from the latch;

FIG. 10 is a view similar to FIG. 9 showing the keeper received in the latch mechanism and suggesting that the keeper sensor is displaced by the keeper to allow the lock pin to engage with a catch of the keeper;

FIG. 11 is a view similar to FIG. 10 showing the lock pin received in the catch of the keeper and suggesting that a lock collar blocks movement of the lock pin relative to the keeper;

FIG. 12 is a front elevation view of the latch mechanism of FIG. 6 showing the keeper and spindle aligned in a first angular position (a) relative to the mount plate;

FIG. 13 is a view similar to FIG. 12 showing the keeper received in the latch mechanism;

FIG. 14 is a view similar to FIG. 12 showing the keeper and spindle aligned in a second angular position ((3) relative to the mount plate and suggesting that a slide pin moves in a slot of the spindle to hold the spindle on the mount plate and allow pivoting movement of the spindle;

FIG. 15 is a rear perspective view of the latch of FIG. 14;

FIG. 16 is a rear elevation view of a handle of a latch actuator of FIG. 1 showing the handle is pivotable about an axis and includes a pair of cam ramps and suggesting that the cam ramps engage with the push rods to drive the push rods away from one another as the handle pivots;

FIG. 17 is a partial side elevation view of the latch mechanism of FIG. 11 showing the push rod engaged with the lock collar and suggesting that movement of the actuator handle drives the push rod toward the lock collar to move the lock collar;

FIG. 18 is a view similar to FIG. 17 showing the push rod and lock collar positioned after movement of the handle;

FIG. 19 is a rear elevation view of another embodiment of a handle of a latch actuator in accordance with the present disclosure showing that the handle is pivotable about an axis and includes a pair of cam ramps and suggesting that the cam ramps engage with cam followers coupled to pull rods to drive the pull rods toward one another as the handle pivots;

FIG. 20 is a partial side elevation view of an opposing end of one of the pull rods of FIG. 19 showing the pull rod engaged with another embodiment of a lock collar and suggesting that movement of the actuator handle drives the pull rod away from the lock collar to move the lock collar; and

FIG. 21 is a view similar to FIG. 20 showing the pull rod and lock collar positioned after movement of the handle.

The exemplification set out herein illustrates embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

The foregoing terms as well as other terms should be broadly interpreted throughout this application to include all known as well as all hereafter discovered versions, equivalents, variations and other forms of the abovementioned terms as well as other terms. The present disclosure is intended to be broadly interpreted and not limited.

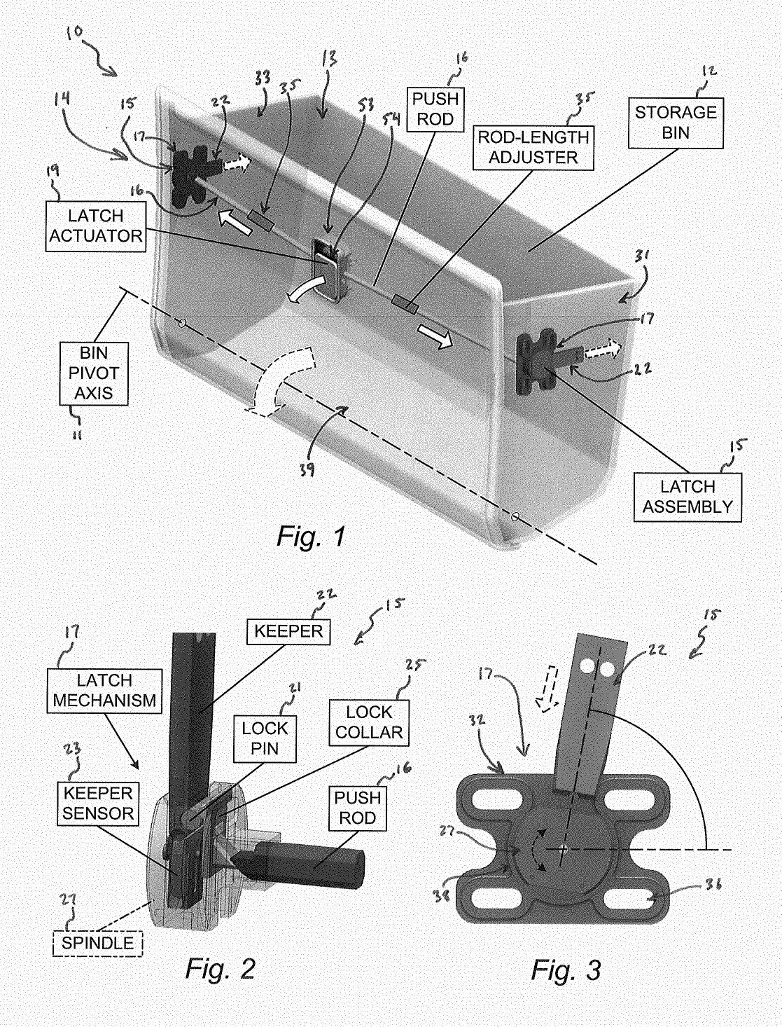

An airplane includes an airframe and one or more utility consoles integrated with the airframe. The utility consoles include a plurality of overhead compartments and a support frame adapted to movably secure the overhead compartments to an upper portion of the airframe. One illustrative embodiment of an overhead compartment 10 in accordance with the present disclosure is shown in FIG. 1. Overhead compartment 10 includes a storage bin 12 and a bin motion controller 14. Each overhead compartment 10 is mounted to the support frame for movement about a pivot axis 11 between a stowed position where an opening 13 of storage bin 12 is covered by the support frame such that contents of storage bin 12 are blocked from passing out of storage bin 12, and a use position where opening 13 of storage bin 12 is exposed so that a user can store or retrieve items from storage bin 12.

Bin motion controller 14 is configured to block or allow movement of overhead compartment 10 about pivot axis 11 at the selection of a user as suggested in FIG. 1. Bin motion controller 14 includes one or more latch assemblies 15 coupled to storage bin 12, one or more push rods 16, and a latch actuator 19. Keepers 22 coupled to the support frame engage with latch assemblies 15 to hold overhead compartment 10 in the stowed position at the selection of a user. Latch actuator 19 is configured to drive push rods 16 into engagement with latch mechanisms 17 of latches assemblies 15 to release keepers 22 and allow overhead compartment 10 to pivot.

Latch mechanisms 17 each include a lock pin 21, a keeper sensor 23, and a lock collar 25 as suggested in FIG. 2. Lock pin 21, keeper sensor 23, and lock collar 25 are coupled to a spindle 27 for relative movement therewith. Lock pin 21 engages with keeper 22 to hold keeper 22 in latch mechanism 17. Lock collar 25 engages with lock pin 21 to hold lock pin 21 in engagement with keeper 22. Push rod 16 extends into spindle 27 to engage with lock collar 25 to move lock collar 25 relative to spindle 27 and allow disengagement of lock pin 21 from keeper 22.

Spindle 27 of latch mechanism 17 is coupled to a mount plate 32 as shown in FIG. 3. Spindle 27 is pivotable relative to mount plate 32 to allow latch mechanism 17 to accommodate various entry angles of keeper 22. For example, an angular misalignment of keeper 22 relative to latch mechanism 17 during installation of overhead compartment 10, mount plate 32, or keeper 22, or through use and wear of overhead compartment 10, can be compensated for by rotation of spindle 27 relative to mount plate 32. In the illustrative embodiment, spindle 27 is configured to rotate relative to mount plate 32 through engagement with keeper 22 and may not require manual adjustment by a technician.

In the illustrative embodiment, a right-side latch mechanism 17 is coupled to a right-side wall 31 of storage bin 12 and a left-side latch mechanism 17 is coupled to a left-side wall 33 of storage bin 12 as shown in FIG. 1. Latch actuator 19 is coupled to a front wall 39 of storage bin 12 and includes a housing 53 and a handle 54 coupled to housing 53. Push rods 16 extend in opposite directions from latch actuator 19 to latch mechanisms 17.

Rod-length adjusters 35 of push rods 16 allow a length of push rods 16 to be adjusted to compensate for variations in a distance between right-side and left-side walls 31, 33 of storage bin 12 as suggested in FIG. 1. In some embodiments, rod-length adjusters 35 each include a coupling and a spring to allow automatic adjustments in length of push rods 16 during operation of bin motion controller 14. In some embodiments, rod-length adjusters 35 each include a coupling and one or more set screws to allow a technician to adjust the lengths of push rods 16 manually.

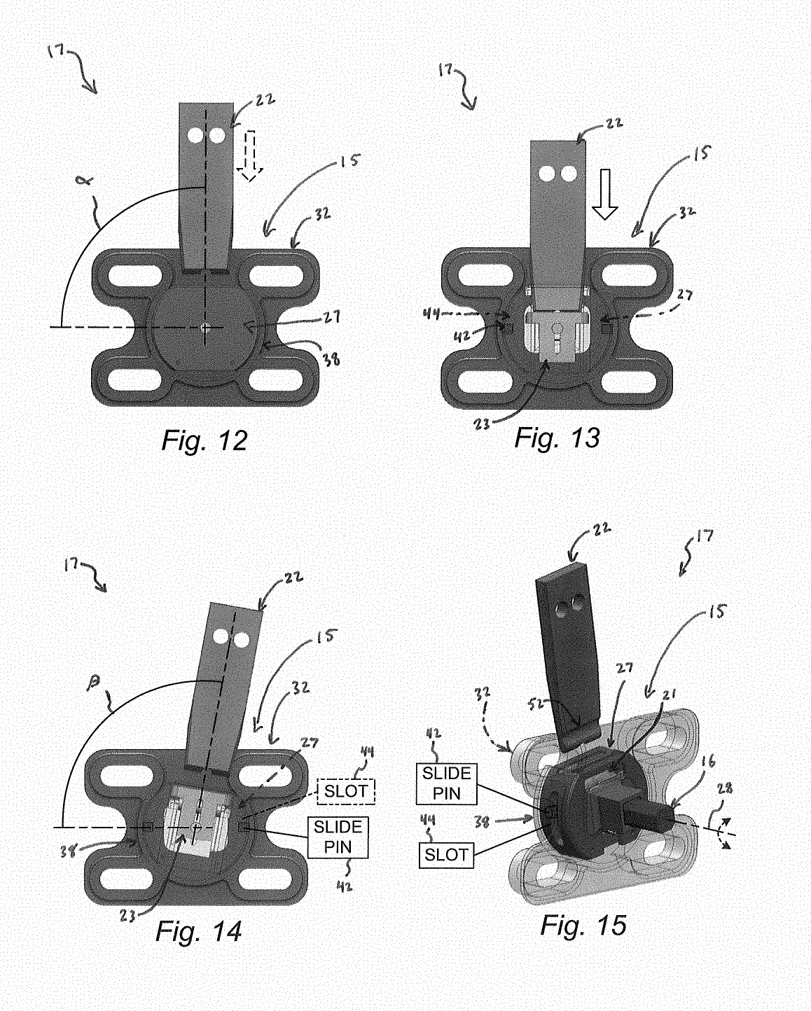

Mount plates 32 each include a plurality of elongated apertures 36 and a spindle receiver 38. Apertures 36 are configured to receive fasteners for attachment of mount plates 32 on storage bin 12 and allow a degree of positional adjustment. Spindle 27 extends into spindle receiver 38 of mount plate 32 and is held to mount plate 32 by one or more slide pins 42. Slide pins 42 extend through spindle receiver 38 and engage with slots 44 formed in spindle 27. In some embodiments, slide pins 42 are partially threaded set screws. Optional alignment springs 41, shown in phantom in FIG. 5, are positioned within slots 44 and engage with spindle 27 and slide pins 42 to bias spindle 27 toward a first angular position (a), such as that shown in FIG. 12. In come embodiments, a snap ring is used in combination with or in place of slide pins 42 to hold spindle 27 onto mount plate 32.

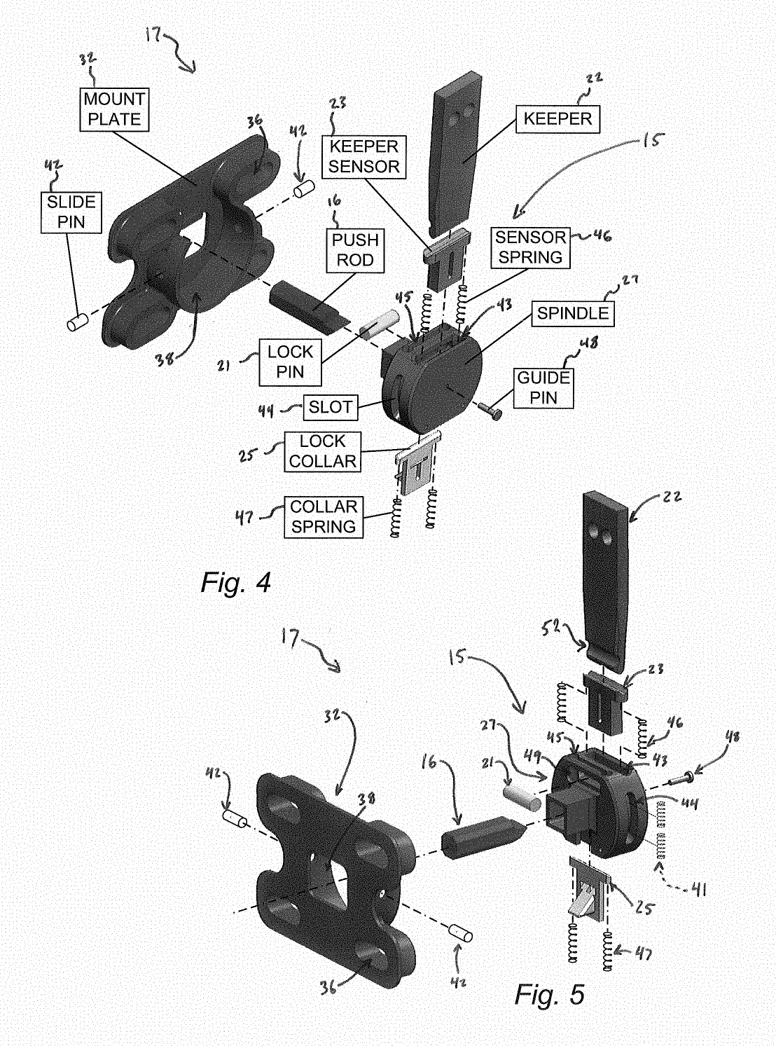

Spindle 27 of latch mechanism 17 is formed to include a sensor cavity 43 and a collar cavity 45 as shown in FIGS. 4 and 5. Keeper sensor 23 and sensor springs 46 extend into sensor cavity 43, and a guide pin 48 engages with spindle 27 and keeper sensor 23 to hold keeper sensor 23 in sensor cavity 43. Lock collar 25 and collar springs 47 extend into collar cavity 45. Lock collar 25 engages with spindle 27 and spindle receiver 38 to hold lock collar 25 in collar cavity 45. Spindle 27 is further formed to include a window 49 configured to allow lock pin 21 to pass into spindle 27 as suggested in FIG. 5. Spindle 27 and mount plate 32 cooperate to capture lock pin 21 within spindle 27 when spindle 27 is coupled to mount plate 32.

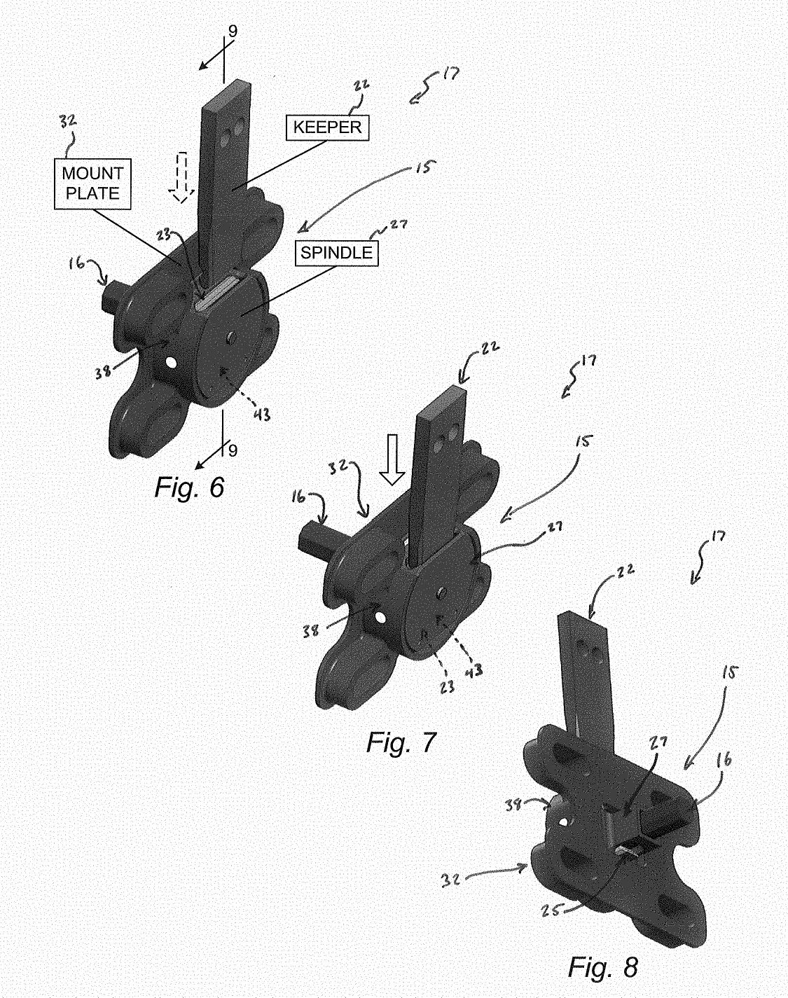

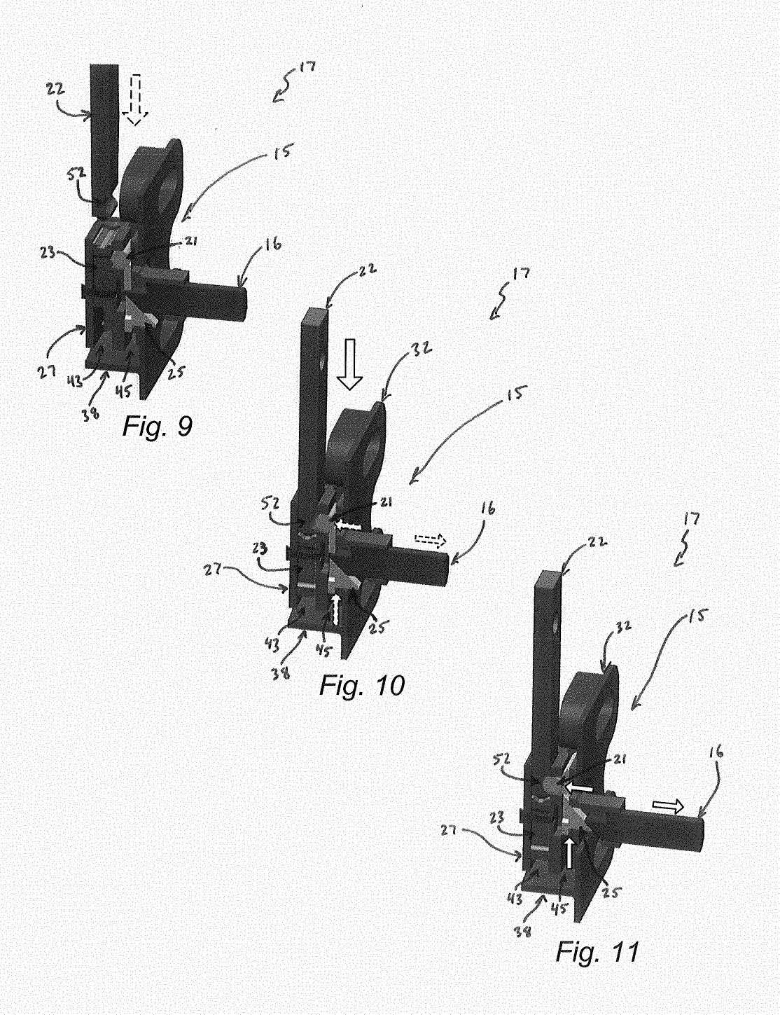

Spindle 27 is coupled to mount plate 32 as suggested in FIGS. 6-8. Keeper 22 extends into sensor cavity 43 to engage with keeper sensor 23 as suggested in FIGS. 6 and 7. Keeper sensor 23 engages with lock pin 21 to block lock pin 21 from entering sensor cavity 43 when keeper 22 is spaced apart from latch mechanism 17 as suggested in FIG. 9. Keeper 22 displaces keeper sensor 23 as keeper 22 is received in sensor cavity 43 as suggested in FIG. 10. Collar springs (not shown in FIG. 11) bias lock collar 25 towards lock pin 21 to drive lock pin 21 into a catch 52 of keeper 22 as suggested in FIG. 11. Lock collar 25 holds lock pin 21 in catch 52 to block removal of keeper 22 from latch mechanism 17. A user engages latch actuator 19 to drive push rod 16 toward latch mechanism 17 and disengage lock collar 25 from lock pin 21 to allow removal of keeper 22 from latch mechanism 17.

Keepers 22 and mount plates 32 are installed with overhead compartment 10 to align keepers 22 with latch mechanisms 17 along a first angular orientation (a) as suggested in FIG. 12. In the first angular orientation (a), keeper 22 passes into sensor cavity 43 of latch mechanism 17 with minimal movement of spindle 27 relative to mount plate 32 as suggested in FIG. 13. Through use of overhead compartment 10, for example, keeper 22 may shift to a second angular orientation ((3) different from the first angular orientation (a) as suggested in FIG. 14. Latch mechanism 17 configured to allow spindle 27 to rotate about a spindle axis 28 relative to mount plate 32 to accommodate for the angular misalignment as suggested in FIG. 15. Keeper 22 engages with spindle 27 to rotate spindle and allow keeper 22 to enter sensor cavity 43 and engage with lock pin 21. Slide pin 42 and slot 44 allow spindle 27 to rotate relative to mount plate 32 while holding spindle 27 on mount plate 32. In some embodiments, slots 44 are wider than slide pins 42 such that spindle 27 is free to move axially relative to mount plate 32 and compensate for a degree of axial misalignment with keeper 22.

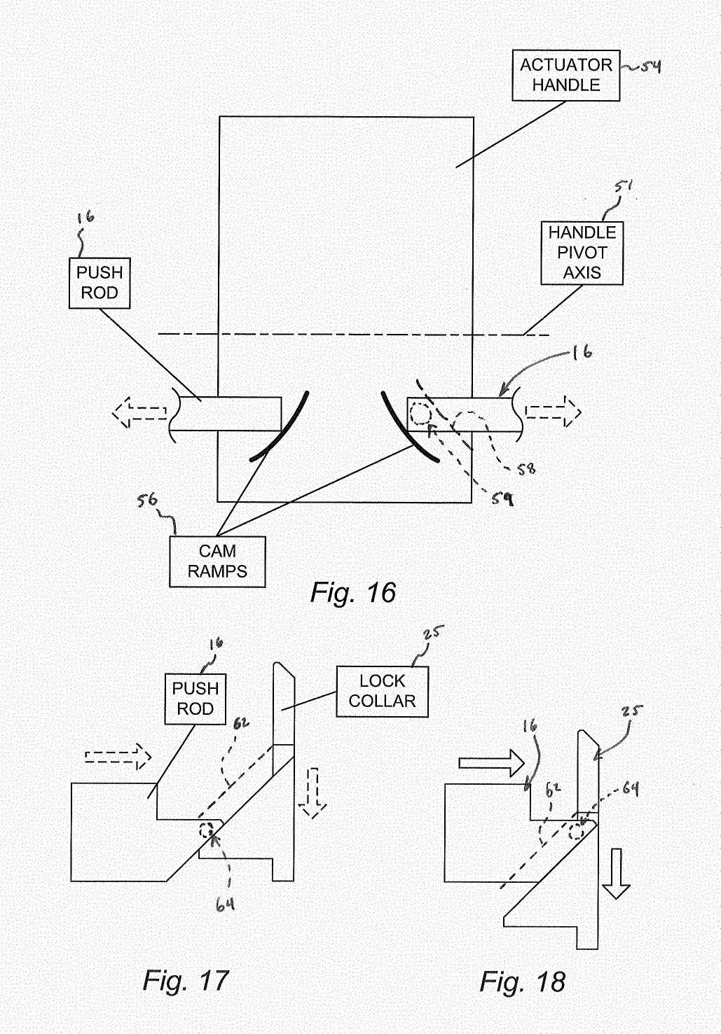

Handle 54 of latch actuator 19 is configured to pivot about a handle axis 51 and includes a pair of cam ramps 56 as suggested in FIG. 16. Cam ramps 56 engage with push rods 16 to drive push rods 16 away from one another as handle 54 pivots about axis 51. In some embodiments, handle 54 includes additional cam ramps 58 positioned to trap a pin or roller 59 coupled to each push rod 16 relative to cam ramps 56. Cam ramps 56 drive push rods 16 toward lock collars 25 to move lock collars 25 as suggested in FIGS. 17 and 18. In some embodiments, lock collar 25 includes an angled slot, as suggested by phantom line 62, configured to trap a pin or roller 64 coupled to push rod 16 for moving lock collar 25.

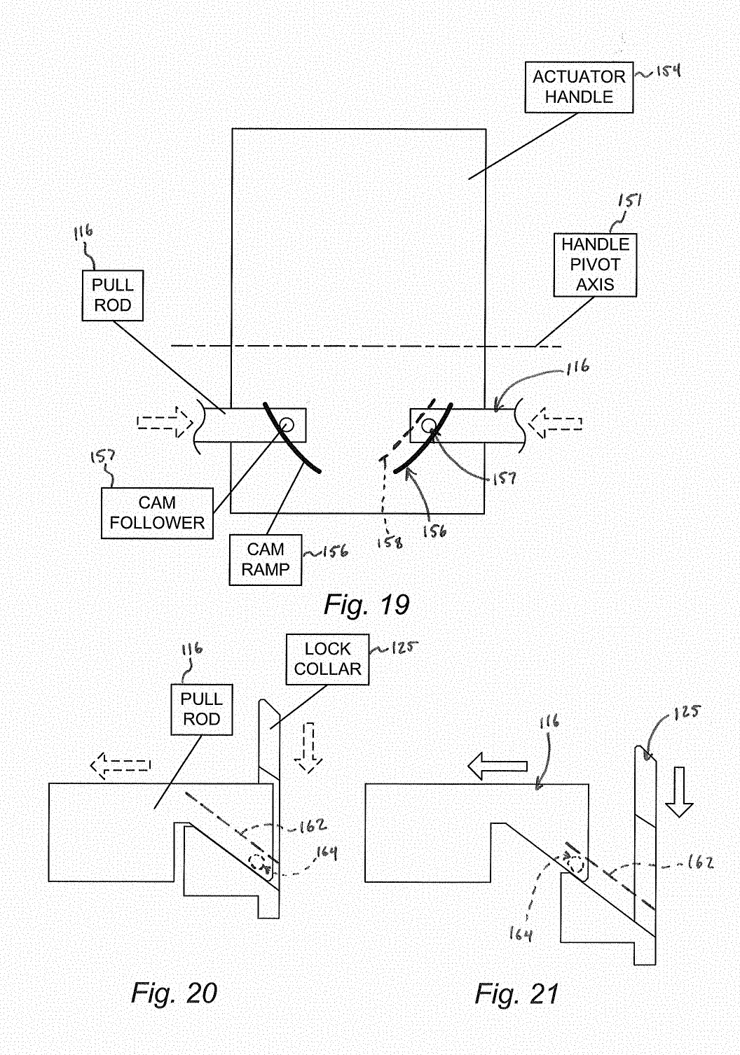

Another embodiment of a handle 154 is configured to pivot about a handle axis 151 and includes a pair of cam ramps 156 as suggested in FIG. 19. Cam ramps 156 engage with cam followers 157 coupled to a pair of pull rods 116 to drive pull rods 116 toward one another as handle 154 pivots about axis 151. In some embodiments, handle 154 includes additional cam ramps 158 positioned to trap cam followers 157 relative to cam ramps 156. Cam ramps 156 drive push rods 116 away from lock collars 125 to move lock collars 125 as suggested in FIGS. 20 and 21. In some embodiments, lock collar 125 includes an angled slot, as suggested by phantom line 162, configured to trap a pin or roller 164 coupled to push rod 116 for moving lock collar 125.

The sizing and materials used to form the various components described herein can be selected based on desired characteristics, such as strength, durability, weatherability, etc. For example, metal and/or plastic materials may be used. In another example, lock pin 21 may be made longer to increase a load capacity of latch assembly 15. In some embodiments, lock pin 21 is replaced by one or more ball bearings.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. The scope of the following claims is to be accorded the broadest interpretation so as to encompass all such modifications and equivalent structures and functions.

1. A latch assembly for use with a storage bin of an overhead compartment, the latch assembly comprising:
a latch mechanism including:
a mount plate adapted to be coupled to the storage bin;
a spindle coupled to the mount plate;
a lock disposed in the spindle;
a keeper sensor disposed in the spindle; and
a lock collar disposed in the spindle; and
a keeper for engaging with the latch mechanism, the keeper formed to define a catch configured to receive the lock pin,
wherein the keeper sensor is configured to block movement of the lock pin when the keeper is spaced apart from the latch mechanism and to allow movement of the lock pin when the keeper is received in the spindle, the lock pin is configured to move relative to the spindle to engage with the catch to block removal of the keeper at the selection of a user when the keeper is received in the spindle, and the lock collar is configured to block removal of the pin from the catch at the selection of a user when the keeper is received in the spindle.

2. The latch assembly of claim 1, wherein the spindle is configured to rotate relative to the mount plate to accommodate varying angles of orientation of the keeper relative to the mount plate.

3. The latch assembly of claim 2, wherein the spindle is formed to include a slot, the spindle is disposed in spindle receiver of the mount plate, and a pin extends through the spindle receiver and into the slot to limit rotation of the spindle relative to the mount plate.

4. The latch assembly of claim 3, wherein the a width of the slot is wider than the pin, and wherein the spindle is configured to translate relative to the mount plate to accommodate varying lateral positions of the keeper relative to the mount plate.

5. The latch assembly of claim 3, further comprising a spring positioned in the slot and engaged between the pin and an end of the slot, and wherein the spring is configured to bias the spindle relative to the mount plate toward a normal orientation.

6. The latch assembly of claim 1, further comprising a push rod extending into the spindle to engage with the lock collar, and wherein the push rod is configured to drive into the spindle and move the lock collar away from the lock pin in response to a user moving a handle of the storage bin.

7. The latch assembly of claim 6, further comprising a rod-length adjuster configured to adjust a length of the push rod to accommodate varying widths of the storage bin.

8. The latch assembly of claim 1, further comprising a pull rod extending into the spindle to engage with the lock collar, and wherein the pull rod is configured to move away from the spindle and move the lock collar away from the lock pin in response to a user moving a handle of the storage bin.

9. The latch assembly of claim 8, further comprising a rod-length adjuster configured to adjust a length of the pull rod to accommodate varying widths of the storage bin.
